(19) United States
(12) Patent Application Publication
(10) Pub. No.: US 2018/0247263 A1
(43) Pub. Date: Aug. 30, 2018

(54) METHOD AND APPARATUS FOR ADJUSTING MERCHANT DELIVERY RANGE

(71) Applicant: Beijing Xiaodu Information Technology Co., Ltd., Beijing (CN)

(72) Inventors: Lang Liu, Beijing (CN); Yue Wang, Beijing (CN); Shaojian Huang, Beijing (CN); Chao Wang, Beijing (CN); Guihua She, Beijing (CN); Peng Yu, Beijing (CN); Dairui Cui, Beijing (CN); Zhuocong Kang, Beijing (CN); Mingquan Xu, Beijing (CN); Fan Jiang, Beijing (CN)

(21) Appl. No.: 15/965,770

(22) Filed: Apr. 27, 2018

Related U.S. Application Data
(63) Continuation of application No. PCT/CN2017/079038, filed on Mar. 31, 2017.

(30) Foreign Application Priority Data
Mar. 31, 2016 (CN) 201610201361.1

(51) Int. Cl. G06Q 10/08; G06Q 10/04

(52) U.S. Cl. CPC G06Q 10/0838; G06Q 10/08355; G06Q 10/047

(57) ABSTRACT

Embodiments of the present invention provide a method and an apparatus for adjusting a merchant delivery range, and the method for adjusting a merchant delivery range includes: obtaining a plurality of historical orders within a preset time period, obtaining a plurality of user groups by means of grouping according to data in the historical orders, and classifying each historical order into a corresponding user group; selecting a to-be-adjusted user group corresponding to a current merchant from the user groups according to information about the current merchant and data in a historical order classified into the corresponding user group; and presenting the to-be-adjusted user group to the current merchant so that the current merchant can adjust a merchant delivery range according to the to-be-adjusted user group. In the method, after historical orders are analyzed, an adjustment policy can be generated, so that a merchant delivery range is adjusted more properly and accurately.

### CROSS REFERENCE

This application is a continuation of International Patent Application No. PCT/CN2017/079038, filed on Mar. 31, 2017 and entitled “METHOD AND APPARATUS FOR ADJUSTING MERCHANT DELIVERY RANGE”, which claims priority to Chinese Patent Application No. 201610201361.1, filed on Mar. 31, 2016 and entitled “METHOD AND APPARATUS FOR ADJUSTING MERCHANT DELIVERY RANGE”, all of which are incorporated herein by reference in its entirety.

### TECHNICAL FIELD

The present invention relates to the field of Internet technologies, and in particular, to a method and an apparatus for adjusting a merchant delivery range.

### BACKGROUND

With the development of Online To Offline (O2O) technologies, more and more users are purchasing goods online. After a user purchases goods online and generates an order, a merchant needs to perform offline delivery.

In related technologies, a merchant delivery range is defined according to human experience, common knowledge, and the surrounding geographic information of the merchant, such as static attributes of roads, rivers, overpasses, or mass transit lines. If the geographic information is not changed, an improper delivery range is usually only adjusted according to feedback of a food delivery person or field research of a business person. Such adjustment process is time-consuming, laborious, and is often not accurate.

### SUMMARY

The present invention is intended to solve one of technical problems in related technologies.

Therefore, an objective of the present invention is to provide a method for adjusting a merchant delivery range. In accordance to the method, after historical orders are analyzed, an adjustment policy can be generated, so that a merchant delivery range is adjusted more properly and accurately.

Another objective of the present invention is to provide an apparatus for adjusting a merchant delivery range.

To achieve the foregoing objective, a method for adjusting a merchant delivery range provided in an embodiment of a first aspect of the present invention includes: obtaining a plurality of historical orders within a preset time period, obtaining a plurality of user groups by means of grouping according to data in the historical orders, and classifying each historical order into a corresponding user group; selecting a to-be-adjusted user group corresponding to a current merchant from the user groups according to information about the current merchant and data in a historical order classified into the corresponding user group; and presenting the to-be-adjusted user group to the current merchant so that the current merchant can adjust a merchant delivery range according to the to-be-adjusted user group.

In the method for adjusting a merchant delivery range provided in the first embodiment of the first aspect of the present invention, after historical orders are analyzed, a to-be-adjusted user group is determined and presented to a merchant. Therefore, the problem associated with adjusting delivery range by a delivery person or a business person after performing field research can be avoided, and the merchant delivery range is properly adjusted in light of the behaviors of the merchant and user groups to avoid unnecessary costs and to increase potential incomes.

To achieve the foregoing objective, an apparatus for adjusting a merchant delivery range provided in an embodiment of a second aspect of the present invention includes: an obtaining module, configured to: obtain a plurality of historical orders within a preset time period, obtain a plurality of user groups by means of grouping according to data in the historical orders, and classify each historical order into a corresponding user group; a determining module, configured to select a to-be-adjusted user group corresponding to a current merchant from the user group according to information about the current merchant and data in each historical order classified into the corresponding user group; and a presentation module, configured to present the to-be-adjusted user group to the current merchant so that the current merchant can adjust a merchant delivery range according to the to-be-adjusted user group.

In an embodiment, the structure of the apparatus for adjusting a merchant delivery range includes a processor and a memory. The memory is configured to store a program that supports the apparatus for adjusting a merchant delivery range in executing the method for adjusting a merchant delivery range in the first aspect, and the processor is configured to execute the program stored in the memory. The apparatus for adjusting a merchant delivery range may further include a communications interface, configured to implement communication between the apparatus for adjusting a merchant delivery range and another device or a communications network.

According to a third aspect of the present invention, an embodiment provides a computer storage medium, configured to store a computer software instruction used by an apparatus for adjusting a merchant delivery range, where the computer software instruction includes a program that is used to execute the method for adjusting a merchant delivery range in the first aspect and that is designed for the apparatus for adjusting a merchant delivery range.

According to the apparatus for adjusting a merchant delivery range provided in the embodiments of the second aspect and the third aspect of the present invention, after historical orders are analyzed, a to-be-adjusted user group is determined and presented to a merchant. Therefore, the problem associated with adjusting delivery range by a delivery person or a business person after performing field research can be avoided, and the merchant delivery range is properly adjusted in light of the behaviors of the merchant and user groups to avoid unnecessary costs and to increase potential incomes.

Some additional aspects and advantages of the present invention are provided in the following descriptions, while some additional aspects and advantages will be apparent in the following descriptions, or can be learned from practicing the present invention.

### BRIEF DESCRIPTION OF DRAWINGS

The accompanying drawings described herein are intended to provide a further understanding of the present invention, and constitute a part of the present invention. The illustrative embodiments of the present invention and descriptions thereof are intended to explain the present invention, and do not constitute a limitation on the present invention. In the accompanying drawings:

FIG. 1 is a schematic flowchart of a method for adjusting a merchant delivery range according to an embodiment of the present invention;

FIG. 2 is a schematic flowchart of a method for adjusting a merchant delivery range according to another embodiment of the present invention;

FIG. 3 is a schematic flowchart of determining a to-be-deleted user group according to an embodiment of the present invention;

FIG. 4 is a schematic flowchart of determining whether a POI is near a boundary of a merchant delivery range according to an embodiment of the present invention;

FIG. 5 is a schematic diagram in which a POI is near a boundary of a merchant delivery range according to an embodiment of the present invention;

FIG. 6 is a schematic diagram in which a POI is not near a boundary of a merchant delivery range according to an embodiment of the present invention;

FIG. 7 is a schematic flowchart of determining a user group whose delivery fee is to be increased according to an embodiment of the present invention;

FIG. 8 is a schematic flowchart of determining a user group whose delivery range is to be expanded according to an embodiment of the present invention;

FIG. 9 is a schematic structural diagram of an apparatus for adjusting a merchant delivery range according to an embodiment of the present invention;

FIG. 10 is a schematic structural diagram of an apparatus for adjusting a merchant delivery range according to another embodiment of the present invention; and

FIG. 11 is a schematic structural diagram of an apparatus for adjusting a merchant delivery range according to still another embodiment of the present invention.

### DESCRIPTION OF EMBODIMENTS

To make the objectives, technical solutions, and advantages of the present invention clearer, the technical solutions of the present invention are described in reference to the specific embodiments of the present invention and the corresponding accompanying drawings. Apparently, the described embodiments are only some rather than all of the embodiments of the present invention. All other embodiments obtained by persons of ordinary skill in the art based on the embodiments of the present invention without creative efforts shall fall within the scope of the present invention.

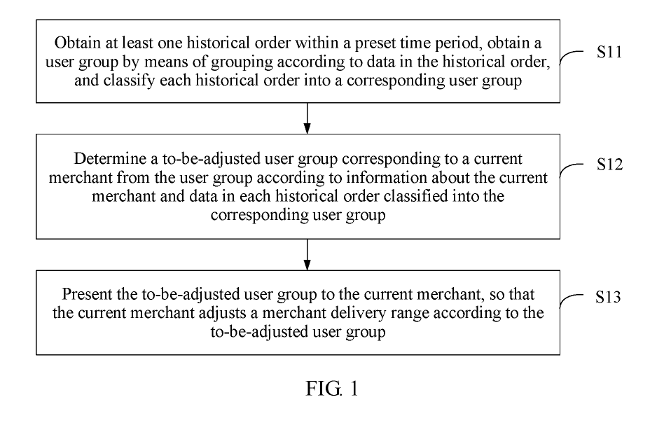

FIG. 1 is a schematic flowchart of a method for adjusting a merchant delivery range according to an embodiment of the present invention.

Referring to FIG. 1, the method in this embodiment includes the following steps.

S11: Obtain historical orders within a preset time period, obtain a user group by means of grouping according to data in the historical orders, and classify each historical order into a corresponding user group.

The historical order may include historical orders of a plurality of merchants, and each merchant may include one or more historical orders.

Data in each historical order may include an order amount, delivery duration, a merchant location, and a user location.

All users may be grouped according to the user location in the data in the historical orders, to obtain one or more user groups.

Specifically, when grouping is performed to obtain a user group, users whose user locations fall within a same preset range may be grouped into the same user group. Each user group may be represented by using one point of interest (point of interest, POI). For example, a POI is a commercial district of Xi'erqi.

After the user group is obtained by means of grouping, for each historical order, the user location may be used to determine the user group into which the historical order is classified.

S12: Determine a to-be-adjusted user group corresponding to a current merchant from the user group according to information about the current merchant and data in each historical order classified into the corresponding user group.

The to-be-adjusted user group may include a to-be-deleted user group, a user group whose delivery fee is to be increased, or a user group whose delivery range is to be expanded.

Different types of to-be-adjusted user groups may be determined by using different parameters. For specific examples, please refer to subsequent embodiments.

S13: Present the to-be-adjusted user group to the current merchant so that the current merchant can adjust a merchant delivery range according to the to-be-adjusted user group.

For example, for the current merchant, if a first user group, a second user group, and a third user group are respectively the to-be-deleted user group, the user group whose delivery fee is to be increased, and the user group whose delivery range is to be expanded, the first user group, the second user group, and the third user group may be presented to the current merchant, and the current merchant may delete the first user group according to delivery range requirement, increase a delivery fee of the second user group, or expand the delivery range to cover the third user group.

In this embodiment, after historical orders are analyzed, a to-be-adjusted user group is determined and presented to a merchant. Therefore, the problem associated with adjusting delivery range by a delivery person or a business person after performing field research can be avoided, and the merchant delivery range is properly adjusted in light of the behaviors of the merchant and user groups to avoid unnecessary costs and to increase potential incomes.

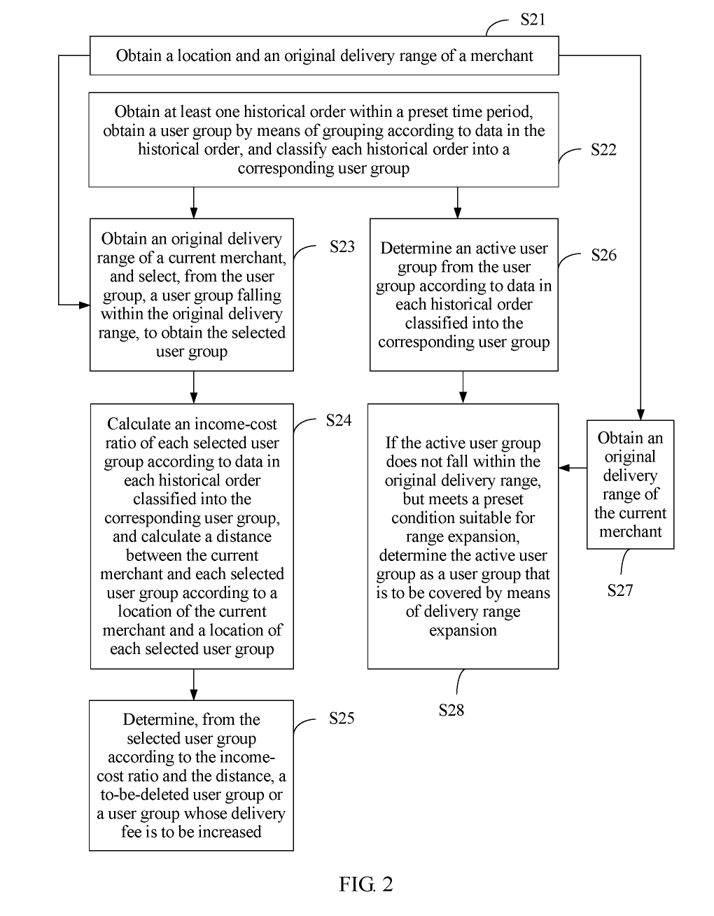

FIG. 2 is a schematic flowchart of a method for adjusting a merchant delivery range according to another embodiment of the present invention.

Referring to FIG. 2, the method in this embodiment includes the following steps.

S21: Obtain a location and an original delivery range of a merchant.

A location of each merchant involved in existing historical orders and an original delivery range of the merchant may be obtained.

S22: Obtain historical orders within a preset time period, obtain a user group by means of grouping according to data in the historical orders, and classify each historical order into a corresponding user group.

The preset time period may be set according to the actual implementation.

Each historical order may include the following data: an order amount, delivery duration, a merchant location, and a user location.

All users whose user locations are located within the same area may be classified as one user group. The user location may be used to determine the user group into which a historical order is classified.

After the data in the historical order is obtained, an income and costs of each historical order may be further calculated. For example, an order amount of the historical order is used as the income, and delivery duration is converted into the costs according to the wage of a delivery person. Therefore, an income-cost ratio of each historical order may be calculated according to the income and costs of each historical order, and the average value of income-cost ratios of all historical orders in the same user group may be used as an income-cost ratio of the user group.

In addition, a merchant-user group distance may be calculated according to a location of a merchant and a location of a user group. The user group occupies an area having a specific shape and a specific size. During calculation of the distance, the longest distance or the shortest distance between the merchant and the area occupied by the user group may be calculated, or a distance between the merchant and a center point of the user group may be calculated. Which type of distance to be used may be set in accordance to requirements.

It should be understood that the foregoing steps may be used as a data preparation and pre-processing procedure, and completed before delivery range adjustment.

When the foregoing data is obtained, a merchant delivery range may be adjusted.

In this embodiment, an adjustment policy includes the following three types:

(1) deleting, from the merchant delivery range, a user group (which is represented by using a POI in the following) whose income-cost ratio is excessively low;

(2) increasing delivery fees of some POIs that are far from a merchant; and

(3) expanding delivery ranges of some merchants to cover a surrounding active POI.

According to the foregoing adjustment policy, a to-be-deleted POI and a POI whose delivery fee is to be increased may be determined in an original delivery range of a merchant, and a POI whose delivery range is to be expanded may be determined outside the original delivery range of the merchant.

Correspondingly, referring to FIG. 2, after S22 is performed, S23 to S25 may be performed, and/or S26 to S28 may be performed.

S23: Obtain an original delivery range of a current merchant, and select, from the user group, a user group within the original delivery range, to obtain the selected user group.

A POI within the original delivery range may be determined according to a location of each POI and the original delivery range of the merchant.

S24: Calculate an income-cost ratio of each selected user group according to data in each historical order classified into the corresponding user group, and calculate a distance between the current merchant and each selected user group according to a location of the current merchant and a location of each selected user group.

As described above, after the income and the costs of each historical order are obtained, the income-cost ratio of each historical order may be calculated, and an average value of income-cost ratios of all historical orders classified into one POI may be used as an income-cost ratio of the POI.

In addition, a merchant-POI distance may be calculated according to a location of a merchant and a location of a farthest boundary point, a closest boundary point, or a center point (which point to use may be preset, the same in the following description) of a POI.

S25: Determine, from the selected user group according to the income-cost ratio and the distance, a to-be-deleted user group or a user group whose delivery fee is to be increased.

In some embodiments, after order analysis is performed, it may be found that for some merchants, average income-cost ratios of some POIs are excessively low, that is, on average, orders delivered from the merchant to these POIs generate incomes that are less than costs for the platform. In other words, each order generates a loss to some degree. An area close to a merchant delivery boundary is to be deleted from these low-income POIs. Thus, the change to the original delivery range of a merchant is minimized, which minimizes the impact on users.

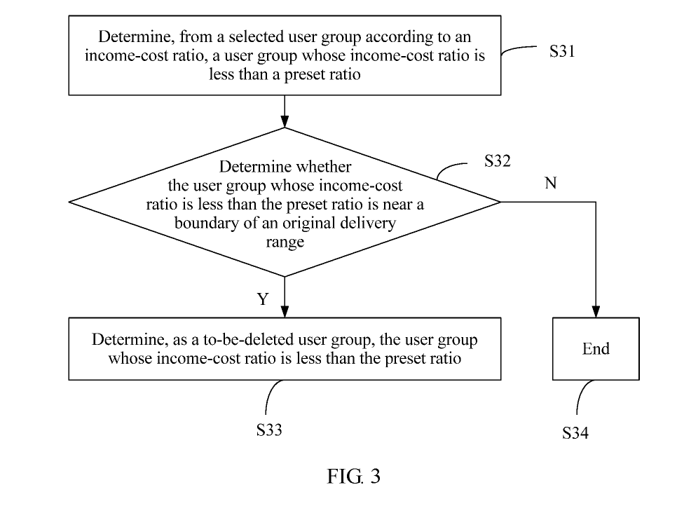

Specifically, referring to FIG. 3, a procedure of determining the to-be-deleted user group may include the following steps.

S31: Determine, from the selected user group according to the income-cost ratio, a user group whose income-cost ratio is less than a preset ratio.

For example, after an income-cost ratio of each POI within the original delivery range of the current merchant is calculated, it may be determined whether the income-cost ratio of each POI is less than the preset ratio. If the income-cost ratio of each POI is not less than the preset ratio, the procedure ends. If the income-cost ratio of each POI is less than the preset ratio, a subsequent procedure is performed.

S32: Determine whether the user group whose income-cost ratio is less than the preset ratio is near a boundary of the original delivery range; and if the user group whose income-cost ratio is less than the preset ratio is near the boundary of the original delivery range, perform S33; if the user group whose income-cost ratio is less than the preset ratio is not near the boundary of the original delivery range, perform S34.

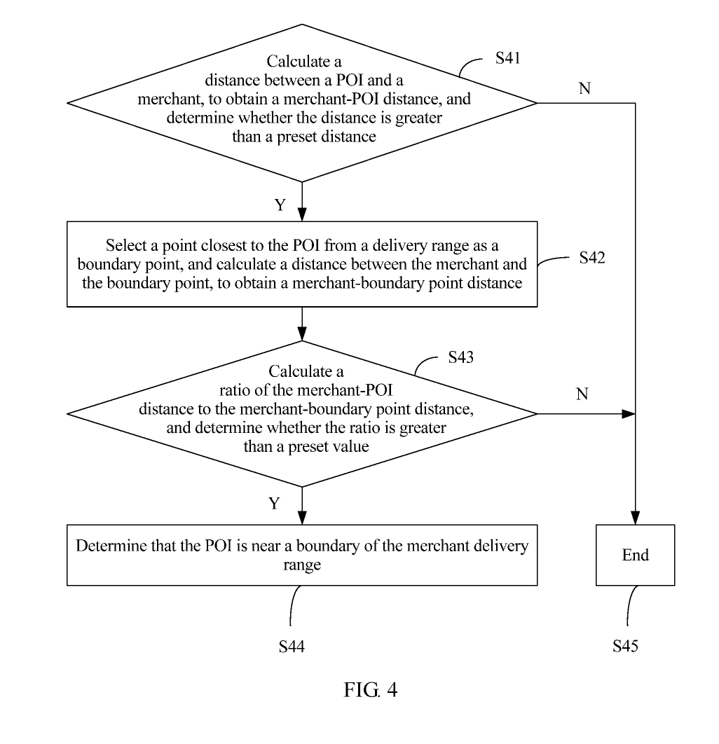

Referring to FIG. 4, a procedure of determining whether a POI is near a boundary of a merchant delivery range may include the following steps.

S41: Calculate a distance between the POI and the merchant, to obtain a merchant-POI distance; determine whether the distance is greater than a preset distance; if the distance is greater than the preset distance, perform S42; if the distance is not greater than the preset distance, perform S45.

The merchant-POI distance may be calculated according to a location of the POI and a location of the merchant.

S42: Select a point closest to the POI from the delivery range as a boundary point, and calculate a distance between the merchant and the boundary point, to obtain a merchant-boundary point distance.

The boundary of the delivery range includes a series of points, and a distance between the POI and each point of the boundary of the delivery range is calculated, so that a point closest to the POI can be determined.

After the boundary point is obtained, the distance between the merchant and the boundary point may be obtained according to a location of the boundary point and the location of the merchant.

S43: Calculate a ratio of the merchant-POI distance to the merchant-boundary point distance; determine whether the ratio is greater than a preset value; if the ratio is greater than the preset value, perform S44; if the ratio is not greater than the preset value, perform S45.

After the two distances are obtained, the ratio between the two distances may be calculated.

S44: Determine whether the POI is near the boundary of the merchant delivery range.

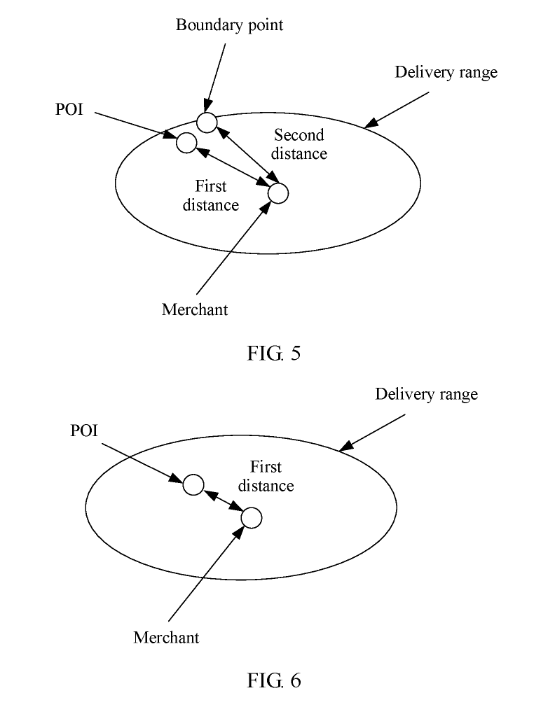

For example, referring to FIG. 5, if a ratio of a first distance to a second distance is greater than the preset value, the POI is near the boundary of the merchant delivery range.

S45: End.

When the merchant-POI distance is less than the preset distance, it indicates that the merchant-POI distance is not excessively long. Therefore, the POI may be considered not near the boundary of the merchant delivery range. For example, referring to FIG. 6, if the first distance is less than the preset distance, the POI is not near the boundary of the merchant delivery range.

Alternatively, if the ratio between the two distances is less than the preset value the POI is considered not near the boundary of the merchant delivery range.

S33: Determine, as the to-be-deleted user group, the user group whose income-cost ratio is less than the preset ratio.

For example, as shown in FIG. 5, if the user group whose income-cost ratio is less than the preset ratio is the POI in FIG. 5, the current merchant is the merchant shown in FIG. 5, and the original delivery range of the current merchant is the merchant delivery range shown in FIG. 5, the POI shown in FIG. 5 may be determined as the to-be-deleted user group of the current merchant.

S34: End.

In some embodiments, delivery distances of most orders fall within a range (for example, less than or equal to k kilometers) according to actual practices. An order whose delivery distance exceeds the k kilometers affects both the user experience and the food delivery experience.

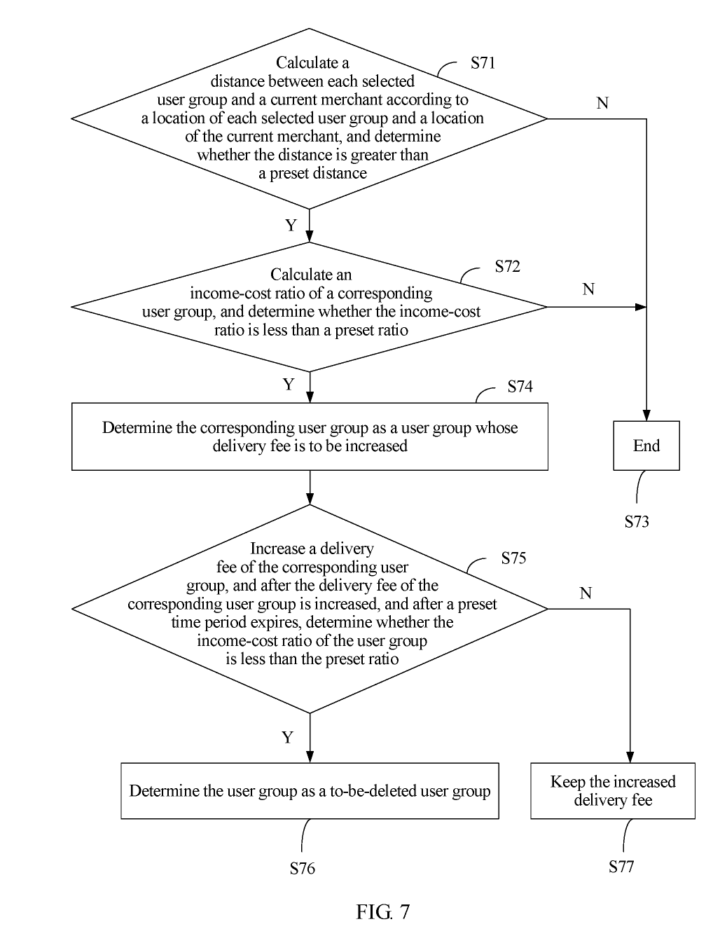

Specifically, referring to FIG. 7, a procedure of determining the user group whose delivery fee is to be increased may include the following steps.

S71: Calculate the distance between each selected user group and the current merchant according to the location of each selected user group and the location of the current merchant; determine whether the distance is greater than a preset distance; if the distance is greater than the preset distance, perform S72; if the distance is not greater than the preset distance, perform S73.

S72: Calculate an income-cost ratio of a corresponding user group; determine whether the income-cost ratio is less than a preset ratio; if the income-cost ratio is less than the preset ratio, perform S74; if the income-cost ratio is not less than the preset ratio, perform S73.

For example, for a selected POI, when a distance between the POI and the current merchant is greater than the preset distance, an income-cost ratio of the POI is calculated.

For the manner of calculating the merchant-POI distance and the income-cost ratio of each POI, please refer to the foregoing descriptions, as details are not repeated herein.

S73: End.

If the income-cost ratio is greater than the preset ratio, it indicates that profitability is acceptable, and no processing may be performed temporarily.

S74: Determine the corresponding user group as the user group whose delivery fee is to be increased.

For example, for the foregoing selected POI, if the distance between the POI and the current merchant is greater than the preset distance, and the income-cost ratio of the POI is less than the preset ratio, the POI may be determined as the POI whose delivery fee is to be increased.

Furthermore, the method may further include the following steps:

S75: Increase a delivery fee of the corresponding user group; after the delivery fee of the corresponding user group is increased, and after a preset time period, determine whether the income-cost ratio of the user group is less than the preset ratio; if the income-cost ratio of the user group is less than the preset ratio, perform S76; if the income-cost ratio of the user group is not less than the preset ratio, perform S77.

An increase range of the delivery fee should be properly set according to experience and the like. Specifically, it may be set that a ratio of the increase range to an order amount is less than a threshold.

After the delivery fee is increased, the income-cost ratio of the POI may be calculated again, to obtain a change of the income-cost ratio.

S76: Determine the user group as the to-be-deleted user group.

S77: Keep the increased delivery fee.

When the income-cost ratio is acceptable after the delivery fee is increased, the delivery fee may be kept.

S26: Determine an active user group from the user group according to data in each historical order classified into the corresponding user group.

A daily average order quantity of each user group may be calculated according to the quantity of historical orders classified into the corresponding user group. A user group whose daily average order quantity is greater than a preset value is determined as the active user group.

For example, statistics about the quantity of daily average historical orders of each POI are collected to obtain the quantity of daily average historical orders, and an average value is calculated according to quantities of daily average historical orders within a preset time period to obtain a daily average order quantity.

S27: Obtain an original delivery range of the current merchant.

S28: If the active user group does not fall within the original delivery range, but meets a preset condition for range expansion, determine the active user group as a user group whose delivery range is to be expanded.

Specifically, referring to FIG. 8, a procedure of determining the user group whose delivery range is to be expanded may include the following steps:

S81: Determine the active POI from the POI according to the data in each historical order classified into the corresponding POI.

For example, statistics about the quantity of historical orders classified into each POI are collected, the daily average order quantity of the corresponding POI is calculated, and a POI whose daily average order quantity is greater than a threshold is determined as the active POI.

S82: Determine whether the active POI falls within the original delivery range of the current merchant; if the active POI falls within the original delivery range of the current merchant, perform S86; if the active POI does not fall within the original delivery range of the current merchant, perform S83.

S83: Calculate a distance between the active POI and the current merchant; determine whether the distance is less than or equal to a preset distance; if the distance is less than or equal to the preset distance, perform S84; if the distance is greater than the preset distance, perform S86.

S84: Determine whether a merchant having a same brand as the current merchant exists in the active POI; if a merchant having a same brand as the current merchant exists in the active POI, perform S86; if no merchant having a same brand as the current merchant exists in the active POI, perform S85.

Different merchants such as chain stores may be respectively set in different areas for the same brand.

S85: Determine the POI as the POI whose delivery range is to be expanded.

S86: End.

In this embodiment, based on the delivery behavior of each merchant reflected in statistics data of historical orders, the value of different types of orders to a logistics platform is analyzed. Accordingly, the number of low-income orders are properly reduced, delivery fees for some types of orders are appropriately increased, the delivery ranges of some merchants are expanded so that they cover additional high-income area, and the resource utilization rate and the income conversion rate of the logistics platform are improved. In addition, better ordering experience is provided for the users, better food delivery experience is provided for the food delivery persons, and more economic incomes are generated for the merchants.

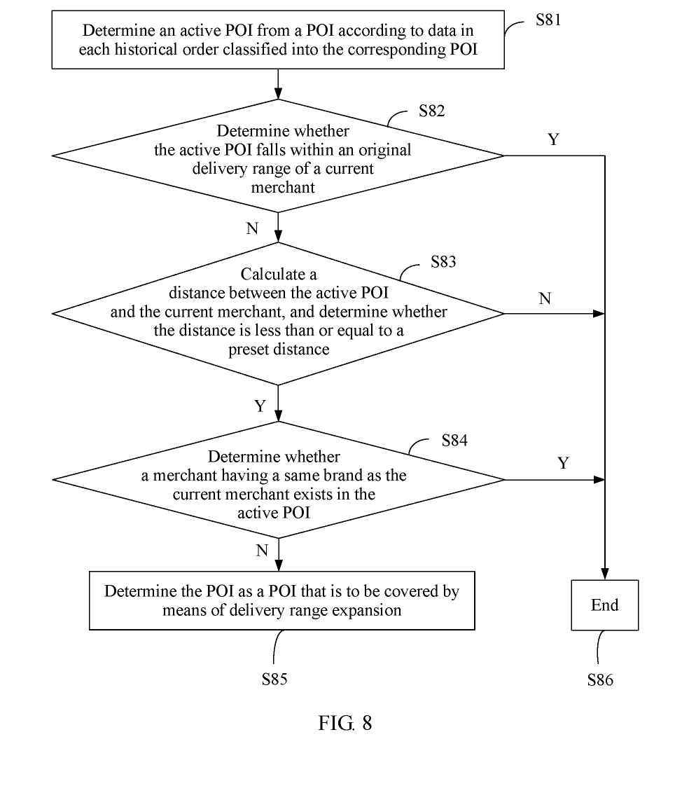

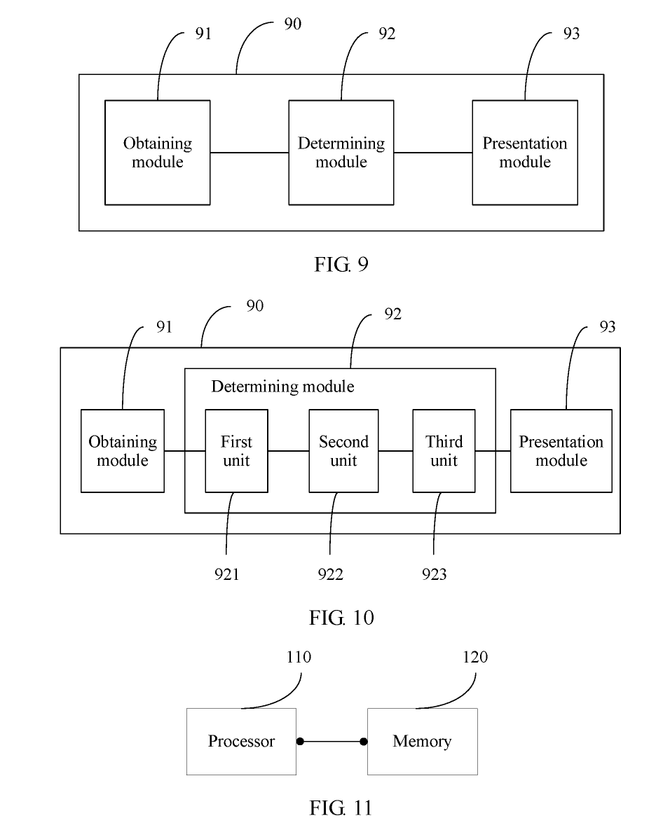

FIG. 9 is a schematic structural diagram of an apparatus 90 for adjusting a merchant delivery range according to an embodiment of the present invention. Referring to FIG. 9, the apparatus 90 includes an obtaining module 91, a determining module 92, and a presentation module 93.

The obtaining module 91 is configured to: obtain historical orders within a preset time period, obtain a user group by means of grouping according to data in the historical orders, and classify each historical order into a corresponding user group.

The determining module 92 is configured to determine a to-be-adjusted user group corresponding to a current merchant from the user group according to information about the current merchant and data in each historical order classified into the corresponding user group.

The presentation module 93 is configured to present the to-be-adjusted user group to the current merchant, so that the current merchant adjusts a merchant delivery range according to the to-be-adjusted user group.

In some embodiments, the to-be-adjusted user group includes a to-be-deleted user group or a user group whose delivery fee is to be increased. Referring to FIG. 10, the determining module 92 includes:

a first unit 921, configured to: obtain an original delivery range of the current merchant, and select, from the user group, a user group falling within the original delivery range, to obtain the selected user group;

a second unit 922, configured to: calculate an income-cost ratio of each selected user group according to the data in each historical order classified into the corresponding user group, and calculate a distance between the current merchant and each selected user group according to a location of the current merchant and a location of each selected user group; and

a third unit 923, configured to determine, from the selected user group according to the income-cost ratio and the distance, the to-be-deleted user group or the user group whose delivery fee is to be increased.

Optionally, the third unit 923 is specifically configured to:

determine, from the selected user group according to the income-cost ratio, a user group whose income-cost ratio is less than a preset ratio;

determine whether the user group whose income-cost ratio is less than the preset ratio is near a boundary of the original delivery range; and

if the user group whose income-cost ratio is less than the preset ratio is near the boundary of the original delivery range, determine, as the to-be-deleted user group, the user group whose income-cost ratio is less than the preset ratio.

Optionally, the third unit 923 is specifically configured to:

calculate a distance between the current merchant and the user group whose income-cost ratio is less than the preset ratio, to obtain a merchant-user group distance;

if the merchant-user group distance is greater than a preset distance, select, from the original delivery range as a boundary point, a point closest to the user group whose income-cost ratio is less than the preset ratio, and calculate a distance between the current merchant and the boundary point, to obtain a merchant-boundary point distance; and

calculate a ratio of the merchant-user group distance to the merchant-boundary point distance, and if the ratio is greater than a preset value, determine that the user group whose income-cost ratio is less than the preset ratio is near the boundary of the original delivery range.

In some embodiments, the third unit 923 is specifically configured to:

calculate the distance between each selected user group and the current merchant according to the location of each selected user group and the location of the current merchant;

if the distance is greater than a preset distance, calculate an income-cost ratio of a corresponding user group; and

if the income-cost ratio is less than a preset ratio, determine the corresponding user group as the user group whose delivery fee is to be increased.

Optionally, the third unit 923 is further configured to:

after a delivery fee of the corresponding user group is increased, if the income-cost ratio is still less than the preset ratio after a preset time period expires, determine the corresponding user group as the to-be-deleted user group.

In some embodiments, the to-be-adjusted user group includes a user group whose delivery range is to be expanded, and the determining module 92 is specifically configured to:

determine an active user group from the user group according to the data in each historical order classified into the corresponding user group;

obtain an original delivery range of the current merchant; and

if the active user group does not fall within the original delivery range, but meets a preset condition suitable for range expansion, determine the active user group as the user group whose delivery range is to be expanded.

Optionally, the determining module 92 is specifically configured to:

calculate a daily average order quantity of each user group according to a quantity of historical orders classified into the corresponding user group; and

determine, as the active user group, a user group whose daily average order quantity is greater than a preset value.

Optionally, the determining module 92 is further configured to:

after it is determined that the active user group does not fall within the original delivery range, calculate a distance between the active user group and the current merchant;

if the distance is less than or equal to a preset distance, determine whether a merchant having a same brand as the current merchant exists in the active user group; and

if no merchant having a same brand as the current merchant exists in the active user group, determine that the active user group meets the preset condition suitable for range expansion.

It may be understood that this embodiment is corresponding to the foregoing method embodiment. For specific content, refer to the related descriptions in the method embodiment. Details are not described herein.

In this embodiment, after historical orders are analyzed, a to-be-adjusted user group is determined and presented to a merchant. Therefore, the problem associated with adjusting delivery range by a delivery person or a business person after performing field research can be avoided, and the merchant delivery range is properly adjusted in light of the behaviors of the merchant and user groups to avoid unnecessary costs and to increase potential incomes. In an embodiment, the apparatus for adjusting a merchant delivery range may be further implemented by using a structure shown in FIG. 11. As shown in FIG. 11, the structure of the apparatus for adjusting a merchant delivery range includes a processor 110 and a memory 120. The memory 120 is configured to store a program that supports the apparatus for adjusting a merchant delivery range in executing the method for adjusting a merchant delivery range provided in the method embodiment, and the processor 110 is configured to execute the program stored in the memory.

The program includes one or more computer instructions, and the one or more computer instructions are invoked and executed by the processor.

The memory 120 is used as a nonvolatile computer readable storage medium, and may be configured to store a nonvolatile software program, and a nonvolatile computer executable program and module, for example, a program instruction/module (such as the obtaining module 91, the determining module 92, and the presentation module 93 that are shown in FIG. 9) corresponding to the method for adjusting a merchant delivery range in the embodiments of the present invention. The processor 110 runs the nonvolatile software program, instruction, and module that are stored in the memory 120, so as to perform various function applications and data processing of an electronic device, that is, implement the method for adjusting a merchant delivery range in the method embodiment.

The processor 110 is configured to: obtain historical orders within a preset time period, obtain a user group by means of grouping according to data in the historical orders, and classify each historical order into a corresponding user group; determine a to-be-adjusted user group corresponding to a current merchant from the user group according to information about the current merchant and data in each historical order classified into the corresponding user group; and present the to-be-adjusted user group to the current merchant, so that the current merchant adjusts a merchant delivery range according to the to-be-adjusted user group.

The processor 110 may execute the method provided in the embodiments of the present invention. For technical details that are of a specific execution process, a corresponding function module, and beneficial effects and that are not described exhaustively in this embodiment, refer to the foregoing content in the present invention.

An embodiment of the present invention provides a computer storage medium, configured to store a computer software instruction used by an apparatus for adjusting a merchant delivery range, where the computer software instruction includes a program that is used to execute the method for adjusting a merchant delivery range in the method embodiment and that is designed for the apparatus for adjusting a merchant delivery range.

Persons skilled in the art should understand that the embodiments of the present invention may be provided as a method, a system, or a computer program product. Therefore, the present invention may include hardware only embodiments, software only embodiments, or embodiments with a combination of software and hardware. Moreover, the present invention may include a computer program product that is implemented on one or more computer-usable storage media (which include but are not limited to a disk memory, a CD-ROM, an optical memory, and the like) storing computer usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of another programmable data processing device generate an apparatus for implementing a specific function in one or more processes in the flowcharts and/or in one or more blocks in the block diagrams.

These computer program instructions may be stored in a computer readable memory that can instruct the computer or the another programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto the computer or the another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPU), an input/output interface, a network interface, and a memory.

The memory may include a non-persistent memory, a random access memory (RAM), a non-volatile memory, and/or another form of a computer readable medium, for example, a read-only memory (ROM) or a flash memory (flash memory). The memory is an example of the computer readable medium.

The computer readable medium includes persistent, non-persistent, movable, and unmovable media that may implement information storage by using any method or technology. Information may be a computer readable instruction, a data structure, a program module, or other data. An example of a computer storage medium includes but is not limited to a phase change memory (PCM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, or a tape and disk storage or another magnetic storage device or any other non-transmission medium that may be configured to store information accessible by the computing device. As defined in this specification, the computer readable medium does not include a transitory computer readable medium (transitory media), such as a modulated data signal and carrier.

It should further be noted that the term “include”, “comprise”, or any other variant thereof is intended to cover non-exclusive inclusion, so that a process, a method, a product, or a device that includes a series of elements not only includes those elements but also includes other elements that are not expressly listed, or further includes elements inherent to the process, method, product, or device. An element preceded by “includes a . . . ” does not, without more constraints, preclude the existence of additional identical elements in the process, method, product, or device that includes the element.

Persons skilled in the art should understand that the embodiments of the present invention may be provided as a method, a system, or a computer program product. Therefore, the present invention may include hardware only embodiments, software only embodiments, or embodiments with a combination of software and hardware. Moreover, the present invention may include a computer program product that is implemented on one or more computer-usable storage media (which include but are not limited to a disk memory, a CD-ROM, an optical memory, and the like) that include computer usable program code.

The foregoing descriptions are only the embodiments of the present invention, and are not intended to limit the present invention. Persons skilled in the art may make various modifications and changes to the present invention. Any modification, equivalent replacement, or improvement made without departing from the spirit and principle of the present invention shall fall within the scope of the claims of the present invention.

What is claimed is:

1. A method for adjusting a merchant delivery range, comprising:
obtaining a plurality of historical orders within a preset time period, obtaining a plurality of user groups by means of grouping according to data in the historical orders, and classifying each historical order into a corresponding user group;
selecting a to-be-adjusted user group corresponding to a current merchant from the user groups according to information about the current merchant and data in a historical order classified into the corresponding user group; and
presenting the to-be-adjusted user group to the current merchant so that the current merchant can adjust a merchant delivery range according to the to-be-adjusted user group.

2. The method according to claim 1, wherein the to-be-adjusted user group comprises a to-be-deleted user group or a user group whose delivery fee is to be increased, and selecting a to-be-adjusted user group corresponding to a current merchant from the user groups according to information about the current merchant and data in a historical order classified into the corresponding user group comprises:
obtaining an original delivery range of the current merchant, and selecting, from the user groups, a plurality of user groups within the original delivery range, to obtain a plurality of selected user group;
calculating an income-cost ratio of each selected user group according to data in a historical order classified into the corresponding user group, and calculating a distance between the current merchant and each selected user group according to a location of the current merchant and a location of each selected user group; and
selecting, from the selected user groups according to the income-cost ratio and the distance, the to-be-deleted user group or the user group whose delivery fee is to be increased.

3. The method according to claim 2, wherein selecting, from the selected user groups according to the income-cost ratio and the distance, the to-be-deleted user group or the user group whose delivery fee is to be increased comprises:
selecting, from the selected user groups according to the income-cost ratio, a user group whose income-cost ratio is less than a preset ratio;
determining whether the user group whose income-cost ratio is less than the preset ratio is near a boundary of the original delivery range; and
if the user group whose income-cost ratio is less than the preset ratio is near the boundary of the original delivery range, selecting, as the to-be-deleted user group, the user group whose income-cost ratio is less than the preset ratio.

4. The method according to claim 3, wherein determining whether the user group whose income-cost ratio is less than the preset ratio is near a boundary of the original delivery range comprises:
calculating a distance between the current merchant and the user group whose income-cost ratio is less than the preset ratio to obtain a merchant-user group distance;
if the merchant-user group distance is greater than a preset distance, selecting a point closest to the user group whose income-cost ratio is less than the preset ratio within the original delivery range as a boundary point, and calculating a distance between the current merchant and the boundary point to obtain a merchant-boundary point distance; and
calculating a ratio of the merchant-user group distance to the merchant-boundary point distance, and if the ratio is greater than a preset value, determining that the user group whose income-cost ratio is less than the preset ratio is near the boundary of the original delivery range.

5. The method according to claim 2, wherein selecting, from the selected user groups according to the income-cost ratio and the distance, the to-be-deleted user group or the user group whose delivery fee is to be increased comprises:
calculating the distance between each selected user group and the current merchant according to the location of each selected user group and the location of the current merchant;
if the distance is greater than a preset distance, calculating an income-cost ratio of the corresponding user group; and
if the income-cost ratio is less than a preset ratio, selecting the corresponding user group as the user group whose delivery fee is to be increased.

6. The method according to claim 5, further comprising:
after a delivery fee of the corresponding user group is increased, if the income-cost ratio is still less than the preset ratio after a preset time period, selecting the corresponding user group as the to-be-deleted user group.

7. The method according to claim 1, wherein the to-be-adjusted user group comprises a user group whose delivery range is to be expanded, and selecting a to-be-adjusted user group corresponding to a current merchant from the user groups according to information about the current merchant and data in a historical order classified into the corresponding user group comprises:
determining an active user group from the user groups according to the data in a historical order classified into the corresponding user group;
obtaining an original delivery range of the current merchant; and
if the active user group is not within the original delivery range, but meets a preset condition for range expansion, selecting the active user group as the user group whose delivery range is to be expanded.

8. The method according to claim 7, wherein determining an active user group from the user groups according to the data in a historical order classified into the corresponding user group comprises:
calculating a daily average order quantity of each user group according to a quantity of historical orders classified into the corresponding user group; and
selecting, as the active user group, a user group whose daily average order quantity is greater than a preset value.

9. The method according to claim 7, further comprising:
after it is determined that the active user group is not within the original delivery range, calculating a distance between the active user group and the current merchant;
if the distance is less than or equal to a preset distance, determining whether a merchant having a same brand as the current merchant exists in the active user group; and
if no merchant having the same brand as the current merchant exists in the active user group, determining that the active user group meets the preset condition for range expansion.

10. An apparatus for adjusting a merchant delivery range, comprising:
an obtaining module, configured to: obtain a plurality of historical orders within a preset time period, obtain a plurality of user groups by means of grouping according to data in the historical orders, and classify each historical order into a corresponding user group;
a determining module, configured to select a to-be-adjusted user group corresponding to a current merchant from the user group according to information about the current merchant and data in each historical order classified into the corresponding user group; and
a presentation module, configured to present the to-be-adjusted user group to the current merchant so that the current merchant can adjust a merchant delivery range according to the to-be-adjusted user group.

11. The apparatus according to claim 10, wherein the to-be-adjusted user group comprises a to-be-deleted user group or a user group whose delivery fee is to be increased, and the determining module comprises:
a first unit, configured to: obtain an original delivery range of the current merchant, and select, from the user groups, a plurality of user groups within the original delivery range, to obtain the selected user groups;
a second unit, configured to: calculate an income-cost ratio of each selected user group according to data in a historical order classified into each selected user group, and calculate a distance between the current merchant and each selected user group according to a location of the current merchant and a location of each selected user group; and
a third unit, configured to select, from the selected user groups according to the income-cost ratio and the distance, the to-be-deleted user group or the user group whose delivery fee is to be increased.

12. The apparatus according to claim 11, wherein the third unit is further configured to:
select, from the selected user groups according to the income-cost ratio, a user group whose income-cost ratio is less than a preset ratio;
determine whether the user group whose income-cost ratio is less than the preset ratio is near a boundary of the original delivery range; and
if the user group whose income-cost ratio is less than the preset ratio is near the boundary of the original delivery range, select, as the to-be-deleted user group, the user group whose income-cost ratio is less than the preset ratio.

13. The apparatus according to claim 12, wherein the third unit is further configured to:
calculate a distance between the current merchant and the user group whose income-cost ratio is less than the preset ratio, to obtain a merchant-user group distance;
if the merchant-user group distance is greater than a preset distance, select a point closest to the user group whose income-cost ratio is less than the preset ratio within the original delivery range as a boundary point, and calculate a distance between the current merchant and the boundary point, to obtain a merchant-boundary point distance; and
calculate a ratio of the merchant-user group distance to the merchant-boundary point distance, and if the ratio is greater than a preset value, determine that the user group whose income-cost ratio is less than the preset ratio is near the boundary of the original delivery range.

14. The apparatus according to claim 11, wherein the third unit is further configured to:
calculate the distance between each selected user group and the current merchant according to the location of each selected user group and the location of the current merchant;
if the distance is greater than a preset distance, calculate an income-cost ratio of a corresponding user group; and
if the income-cost ratio is less than a preset ratio, select the corresponding user group as the user group whose delivery fee is to be increased.

15. The apparatus according to claim 14, wherein the third unit is further configured to:
after a delivery fee of the corresponding user group is increased, if the income-cost ratio is still less than the preset ratio after a preset time period, select the corresponding user group as the to-be-deleted user group.

16. The apparatus according to claim 10, wherein the to-be-adjusted user group comprises a user group whose delivery range is to be expanded, and the determining module is further configured to:
determine an active user group from the user groups according to the data in a historical order classified into the corresponding user group;
obtain an original delivery range of the current merchant; and
if the active user group is not within the original delivery range, but meets a preset condition for range expansion, select the active user group as the user group whose delivery range is to be expanded.

17. The apparatus according to claim 16, wherein the determining module is further configured to:
calculate a daily average order quantity of each user group according to a quantity of historical orders classified into the corresponding user group; and
select, as the active user group, a user group whose daily average order quantity is greater than a preset value.

18. The apparatus according to claim 16, wherein the determining module is further configured to:
after it is determined that the active user group is not within the original delivery range, calculate a distance between the active user group and the current merchant;
if the distance is less than or equal to a preset distance, determine whether a merchant having a same brand as the current merchant exists in the active user group; and
if no merchant having the same brand as the current merchant exists in the active user group, determine that the active user group meets the preset condition suitable for range expansion.

19. An apparatus for adjusting a merchant delivery range, comprising a memory and a processor, wherein
the memory is configured to store one or more computer instructions, and the one or more computer instructions are invoked and executed by the processor; and
the processor is configured to: obtain a plurality of historical orders within a preset time period, obtain a plurality of user groups by means of grouping according to data in the historical orders, and classify each historical order into a corresponding user group; select a to-be-adjusted user group corresponding to a current merchant from the user groups according to information about the current merchant and data in each historical order classified into the corresponding user group; and present the to-be-adjusted user group to the current merchant so that the current merchant can adjust a merchant delivery range according to the to-be-adjusted user group.
